(19) United States
(12) Patent Application Publication
(10) Pub. No.: US 2005/0005122 A1
(43) Pub. Date: Jan. 6, 2005

(54) Optical encoding

(76) Inventor: Nigel Christopher Abraham, Washington (GB)

Correspondence Address: Edwin D Schindler;Five Hirsch Avenue, P O Box 966, Coram, NY, 11727, US

(21) Appl. No.: 10/491,652

(22) PCT Filed: Oct. 1, 2002
(86) PCT No.: PCT/GB02/04434

(30) Foreign Application Priority Data
Oct. 1, 2001 (GB) 0123468.1
Oct. 2, 2001 (GB) 0123720.5
Apr. 23, 2002 (GB) 0209282.3

(51) Int. Cl. H04L 9/00

(52) U.S. Cl. 713/176

(57) ABSTRACT

An article includes at least one surface with a visual feature included thereon and a plurality of elements with at least a portion of the elements being of selected optical states in accordance with a predetermined code, so that the visual feature is encoded with information. The article further includes a security feature which incorporates a security code with the security feature being formed so that the security code is random, and with the information encoded into the visual feature of the article including a code derived from the security feature and corresponding to the security code.

The present invention relates to a substrate or other article having a surface provided with an alpha-numeric or other visual feature which is optically-encoded with information for identification and/or security purposes.

In accordance with the present invention, there is provided a substrate or other article having a surface provided with an alpha-numeric feature which comprises a plurality of characters, or another visual feature which comprises a plurality of elements, at least some of the characters or elements of said feature being of selected optical states in accordance with a predetermined code.

It will be appreciated that by selecting the optical states of the characters or other elements in accordance with the predetermined code, these characters or other elements can be collectively encoded with any desired information.

Preferably the differences exhibited by each character or element, in its different states, are substantially imperceptible (or not readily perceptible) to the naked eye. The different states of each character or element can however be discriminated by optical character recognition systems.

The alpha-numeric feature may comprise any desired information provided on the substrate or other article, for the benefit of the end user of the article, and typically comprising a succession of words each consisting of one or a series of characters. Alternatively, the visual feature may comprise a bar-code consisting of a number of parallel bars of different widths and spacings. The present invention enables a large amount of additional information to be encoded into the alpha-numeric or other visual feature, for the purposes of identification and/or security against counterfeiting of the product. For example, any one or more of the following items of information may be encoded into the alpha-numeric or other feature: data indicating where the product was manufactured, the date of manufacture, the product name, and the serial number of the product.

In a first embodiment, using binary encoding, a character or element of undistorted shape is regarded as logic state “0”, and the same character or element of substantially the same shape, but with one or more minor alterations or distortions in shape, as logic state “1”. For example, the state “0” for alpha-numeric characters may be provided by a predetermined font, state “1” being provided by corresponding characters from which one or more small areas are removed or added. The alterations may comprise curved or straight-line shapes cut into the edge of the character or other element of the visual feature, or protruding from it, or cut out of the body of the character or other element: preferably such shapes are simple geometric shapes such as squares or rectangles. Alternatively, the alterations may consist of alterations in the thickness of one or more of the lines forming each character or other element. Preferably these alterations change each time the character or element is repeated in the alpha-numeric or other visual feature: thus, each character or element has a number of different alterations in shape, each representing state “1”, which may be selected on a random basis. It may be desirable for each character or element to have a number of alterations in shape, any of which can be read to indicate state “1”, to ensure reliable reading. For example, the visual feature may comprise a bar-code, the elements (i.e. bars) of which are formed with alterations as described above.

In a second embodiment, alpha-numeric characters are selected from two alternative fonts, the corresponding characters in the two fonts being substantially the same but exhibiting one or more minor differences in shape.

In a third embodiment, alpha-numeric characters are selected from a single font, each character in its different states being of identical shape but different in size or shifted from its nominal position within its multi-character word (e.g. displaced slightly to the left or right, or up or down, from its nominal position).

In a fourth embodiment, the different states of each character or element are defined by different shades of colour or different greyscales (the differences preferably being imperceptible to the naked eye), or otherwise different optical responses under incident light. For example, in one logic state, the character or element may be arranged to playback at a different wavelength from the incident light, for example by the provision of a pigment (e.g. fluorescent, rare earth or anti-Stokes pigments). The pigment (e.g. an anti-Stokes pigment) may be such that it plays back in the visible spectrum when illuminated by a longer wavelength laser light. Other pigments or dyes could be used which playback with UV light, or others which fluoresce.

In a fifth embodiment, the visual feature comprises a bar-code consisting of a number of parallel bars, the widths and spacings of which differ in accordance with a code, in conventional manner: in addition, and in accordance with the present invention, some of the bars are shifted (to the right or left or up or down) from their nominal positions, and/or are modified in length, and/or modified in width (from nominal widths), in accordance with a predetermined code, imparting additional information to the feature.

Whilst the above description refers to binary encoding, it will be appreciated that higher orders of encoding may be used. For example, several different states for each character or element may be provided by different alterations in shape, or different combinations of shape alterations, font shapes or sizes or shade differences (or other differences in optical responses) may be employed.

The encoding employed in the alpha-numeric or other feature is preferably encrypted and preferably includes a checksum and/or error correction.

It will be appreciated that the alpha-numeric or other feature may be printed on the substrate or other article using any appropriate form of printer, including inkjet printers, electrostatic printers and thermal transfer printers. The printer is preferably computer-controlled such that successive printed products, or successive batches of printed products, may be encoded differently.

Also, in accordance with the present invention, there is provided an apparatus for applying an alpha-numeric or other visual feature to a surface of a substrate or other article, the apparatus being arranged to apply at least some of the characters or elements of said feature in optical states selected in accordance with a predetermined code.

Further in accordance with the present invention, there is provided an apparatus for reading an alpha-numeric or other visual feature carried on a surface of a substrate or other article, at least some of the characters or elements of said feature being of optical states selected in accordance with a predetermined code, the apparatus being arranged to determine the optical states of said characters or elements and determine the information encoded therein.

As a further security measure, the surface of the substrate or other article may carry a security feature such as a hologram or other optically variable device. Preferably the security feature incorporates a security code, and the information encoded into the alpha-numeric or other visual feature includes the same security code. Then in the reading process, the security code is read from the security feature and compared with the security code decoded from the alpha-numeric or other visual feature: if these two codes fail to match, the product is regarded as being of suspect authenticity.

The security code may be random. Thus, the security feature may be applied in a manner such that it incorporates a security code which is random in nature: the security feature is then examined to read its security code, which is then included in the data to be encoded in the alpha-numeric or other visual feature.

For example, the security feature may be printed onto the substrate surface, the printing ink including particles of pigment which are applied in a random manner. The security feature, once applied, is then examined by machine to plot the positions and/or colours of the pigment particles: from this information, the security code is generated. Instead of using particles of pigment for the security feature, magnetic or electrically-conductive particles may be used, or chemical or other tagging agents, the positions of which are then determined by machine, to generate the security code.

The security feature is preferably provided in an area separate from the alpha-numeric or other visual feature: it may for example form a logo or other design feature on the substrate surface.

Embodiments of the present invention will now be described by way of example only and with reference to the accompanying drawings, in which:

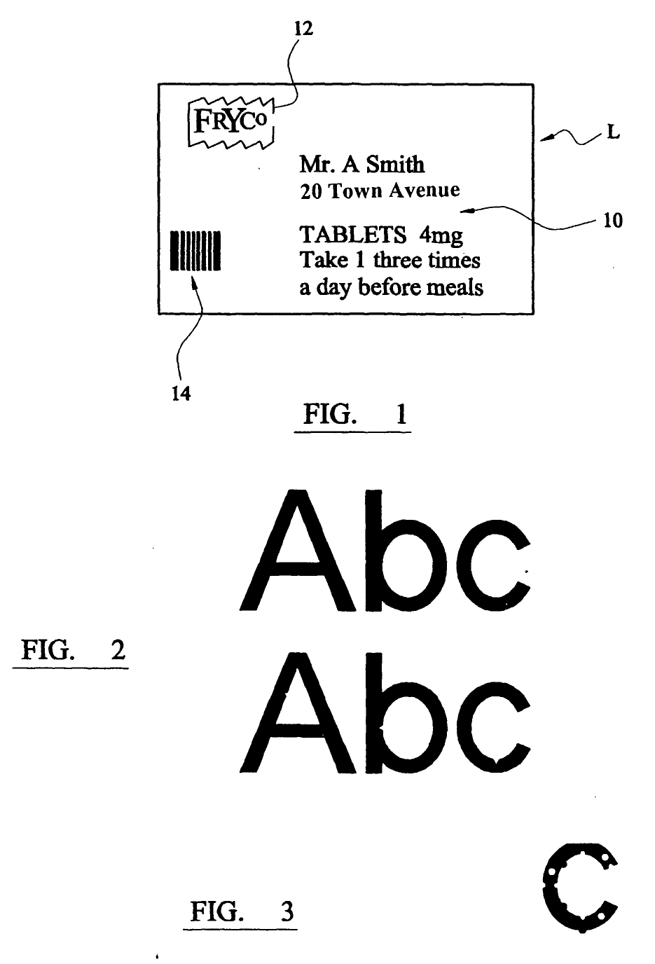

FIG. 1 is a front view of a product label provided with visual features in accordance with the present invention;

FIG. 2 shows several characters in their standard and altered shapes;

FIG. 3 shows a character with a number of alterations from its standard shape;

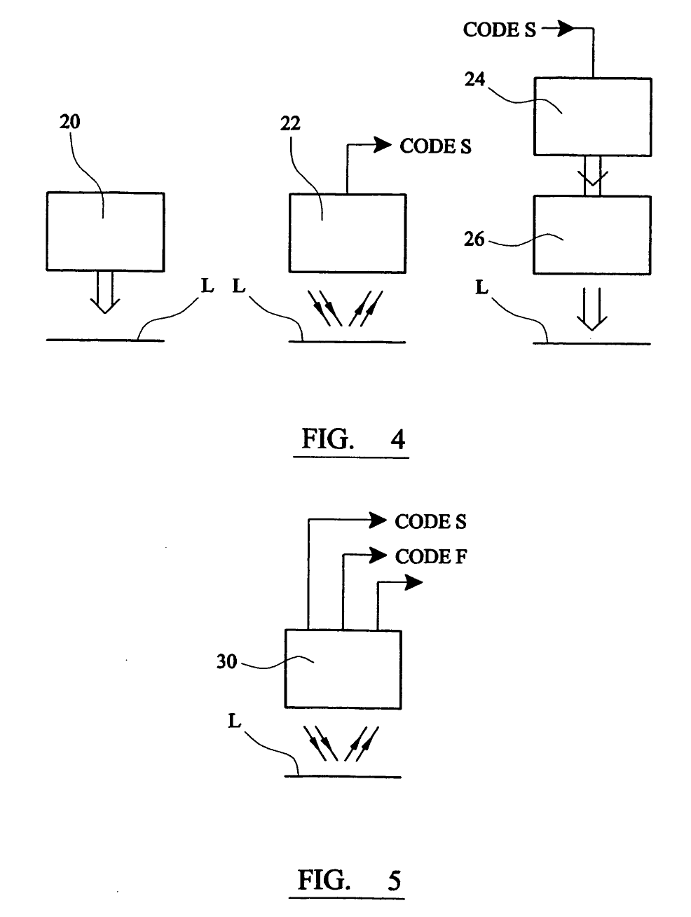

FIG. 4 is a schematic diagram of apparatus for applying a visual feature and a security feature to product labels; and

FIG. 5 is a schematic diagram of an apparatus for reading encoded information from visual features of product labels.

Referring to FIG. 1, there is shown a product label L which is printed with alpha-numeric information 10, consisting of a succession of words each made up of one or a series of characters, and also with the manufacturer's logo 12. The alpha-numeric information may be of any desired content, for the benefit in usual manner of the user of the product: the example shown is a label for prescribed medication for a particular patient. The label is also provided with a machine-readable bar-code 14 made up of a number of parallel bars of different widths and spacings in accordance with a predetermined code. It will be appreciated that the characters of the alpha-numeric information 10 normally occupy nominal positions at regular intervals, as do the bars of the bar code 14.

In accordance with the present invention, at least some of the characters of the alpha-numeric information 10 are of selected optical states, in accordance with a predetermined code. In particular, in the example shown, use is made of binary encoding, in which the characters are selected from a predetermined font without any alteration or distortion in shape (logic state “0”), or are selected from the same font but include minor alterations or distortions in shape (logic state “1”). FIG. 2 shows three characters, firstly in their standard or unaltered states (“0”), and secondly in their altered states (“1”): it will be noted that, in their altered states, the characters have minor sections or areas removed; instead, they could have similar minor areas added, as protrusions, or other differences in shape e.g. lines of different curvature or lines of different thickness.

The difference between a character in its state “0” and the same character in its state “1” is minor and not readily perceptible to the naked eye. However, the different shapes of character can be discriminated reliably using optical reading devices, for example a standard quality desktop scanner coupled to a computer running optical character recognition software.

The altered form of each character may change each time it is repeated, within the alpha-numeric feature, to increase the difficulty of identifying a pattern. For example, there may be 4 or more altered forms for each character, chosen preferably in random and each representing state “1” for that character. Moreover, it may be desirable for each character, in state “1”, to include a number of alterations to ensure reliable reading and a level of redundancy: FIG. 3 shows a character with a number of alterations in shape, some comprising small areas removed, some comprising small areas added, and some comprising voids or small areas removed from within the body of the character (i.e. localised between opposite edges thereof).

In a second embodiment, the characters may be selected from two alternative fonts, the corresponding characters in the two fonts being similar or identical in shape except for one or more minor differences in shape, these differences being imperceptible to the naked eye.

In a third embodiment, the characters may be selected from a single font with each character selected of slightly different sizes or shifted (to the right or left or up or down) from its nominal position within its multi-character word, the differences in size or position again being minor and imperceptible to the naked eye.

In a fourth embodiment, each character may be identical in shape and size, in its states “0” and “1”, but of different colour shades or different greyscales: again, the differences in colour shade are imperceptible to the naked eye. As a further example, and as mentioned previously, in one state the character may include a pigment or other additive to that it gives a different response under incident light (whether in the visible part of the spectrum or outside).

In a fifth embodiment, some of the bars of the bar-code 14 are shifted (to the right or left or up or down) from their nominal positions within the bar-code, and/or some of the bars may be shorter or longer than their nominal lengths, and/or narrow or wider than their nominal widths. The amount of the shift in position of each bar, or the modification in length or width of each bar, is minor and imperceptible to the naked eye. The shifts in position, or modifications in length or width, are in accordance with a predetermined code, imparting information to the bar-code which is additional to its normal machine-readable information. Instead, at least some of the bars of the bar-code may be provided with minor alterations or distortions of shape, in accordance with predetermined code, for example in the form of minor sections removed or added (e.g. as protrusions).

In each of the above-described embodiments, the present invention enables a large amount of information to be encoded into the human-readable alpha-numeric information 10, for the purposes of identification and/or security against product counterfeiting. In addition, in the example shown in FIG. 1, the logo 12 is applied in a manner enabling a random security code to be generated from it, and this random security code is further encoded into the alpha-numeric feature 10 or bar code 14. For example, the product label L shown in FIG. 1 may be printed initially with the logo 12 (or an alternative patch or area), the print incorporating particles of pigment, such as rare earth pigments which play back with long wavelength light: a printer 20 for this purpose is shown in FIG. 4. The pigment particles are accordingly applied to the substrate in random manner. Then the substrate, with printed logo, is examined in a reader 22 (FIG. 4), to plot the positions of the pigment particles, and optionally their respective playback colours, and, using a predetermined algorithm, generate a security code according to the locations of the differently coloured pigment particles. This security code is provided as an output CODE S from the reader 22 and then forms part of the data encoded into the alpha-numeric feature 10 or bar code 14: the output CODE S is used by a computer 24 controlling a printer 26 which prints the alpha-numeric feature 10 and/or bar-code 14.

In subsequently reading the alpha-numeric feature 10 or bar code 14, the logo 12 (or alternative patch) is also read to regenerate the security code from it: this is then compared against the security code read from the alpha-numeric feature 10 or bar code 14. FIG. 5 shows a reader 30 arranged to read the security feature and determine its security code CODE S, and also read the alpha-numeric feature 10 and/or bar-code 14 and determine both its security CODE F and its encoded information.

Because the pigment particles do not playback visible light except under non-visible (infra red) light, the security feature cannot be copied by standard colour-copying equipment: the feature is accordingly secure against counterfeit replication.

Instead of using randomly-applied pigments in the logo 12 (or alternative patch), magnetic particles (preferably particles of high magnetic coercivity) or electrically-conductive particles or fibres, or chemical or other tagging agents may be applied in similar random manner, and similarly used to generate a random security code for inclusion in the information encoded into the alpha-numeric feature 10 or bar code 14. The magnetic particles may be read using a magnetic field, whilst the electrical particles or fibres may be read using an electric field or a microwave field, and the chemical tagging agents may be read using chemical or optical exposure.

As a further security option, an optically variable device (such as a hologram) may be applied to the substrate: this device may include a security code, which is also included in the information encoded into the alpha-numeric feature 10 or into the bar code 14.

As a yet further security option, the security patch may be formed by applying to the substrates, in random manner, discrete dots or other elements of one or more different sheet materials, e.g. hot stamping foils (or other foils). The pattern and/or distribution of these elements of e.g. reflective foil are then read optically, to generate the random security code, as described above. The pattern of foil elements may form an optically variable device. The discrete dots or elements of sheet material may include magnetic, electrical, chemical or other tagging agents enabling their positions to be machine-read.

1-20 (canceled)

21. An article, comprising:
a surface;
a visual feature included on said surface;
a plurality of elements with at least a portion of elements of said plurality of elements being of selected optical states according to a predetermined code, so that said visual feature is encoded with information; and,
a security feature incorporating a security code, said security feature being formed so that said security code is random, said information being encoded into said visual feature includes a code derived from said security feature and corresponding to said security code.

22. The article according to claim 21, wherein each element of said portion of elements includes a first optical state of said selected optical states of a predetermined shape and a second optical state of said selected optical states having a substantially similar shape that differs from said predetermined shape of said first optical state due to a presence of minor alterations.

23. The article according to claim 22, wherein said substantially similar shape of said second optical state differs from said predetermined shape of said first optical state by the presence of an additional small area in said substantially similar shape.

24. The article according to claim 23, wherein said additional small area is added to an edge of said element of said portion of elements.

25. The article according to claim 22, wherein said substantially similar shape of said second optical state differs from said predetermined shape of said first optical state by a removal of a small area in said substantially similar shape as compared to said predetermined shape.

26. The article according to claim 25, wherein said small area is removed from an edge of said element of said portion of elements.

27. The article according to claim 25, wherein said small area is removed from an area within said element of said portion of elements.

28. The article according to claim 22, wherein each said element of said portion of elements includes lines forming said element, with said minor alterations being comprised of a change of thickness of at least one line of said lines forming said element.

29. The article according to claim 28, wherein said change of thickness of at least one said line of said element is an increase of thickness.

30. The article according to claim 28, wherein said change of thickness of at least one said line of said element is an decrease of thickness.

31. The article according to claim 22, wherein said elements of said portion of elements comprise alpha-numeric characters selected from two alternative fonts, each character of said alpha-numeric characters in said two alternative fonts being substantially identical, except for at least one difference in shape.

32. The article according to claim 21, wherein each element of said portion of elements includes a first selected optical state of said selected optical states of a predetermined size and a second selected optical state of said selected optical states of a different size as compared to said predetermined size.

33. The article according to claim 21, wherein said selected optical states includes a first selected optical state and a second optical state with each element of said portion of elements having said first selected optical state occupying a predetermined nominal position and said second optical state occupying a position shifted from said predetermined nominal position.

34. The article according to claim 21, wherein said selected optical states includes a first selected optical state and a second optical state with each element of said portion of elements having said first selected optical state of a predetermined color shade or greyscale and said second selected optical state of a different color shade or grey as compared to said predetermined color shade or grey-scale.

35. The article according to claim 21, wherein said selected optical states includes a first selected optical state and a second selected optical state with each element of said portion of elements having said first optical state comprising a first optical response under incident light and said second selected optical state comprising a second optical response under said incident light, said second optical response being different from said first optical response.

36. The article according to claim 35, wherein each said element of said portion of elements in said first selected optical state plays back light at a different wavelength from said incident light.

37. The article according to claim 35, wherein each said element of said portion of elements in said second selected optical state plays back light at a different wavelength from said incident light.

38. The article according to claim 21, wherein said visual feature comprises a bar-code having a plurality of parallel bars, some parallel bars of said plurality of parallel bars being shifted from their nominal positions according to said predetermined code.

39. The article according to claim 21, wherein said visual feature comprises a bar-code having a plurality of parallel bars, some parallel bars of said plurality of parallel bars being modified from their nominal lengths or nominal widths according to said predetermined code.

40. The article according to claim 21, wherein differences exhibited by each element of said portion of elements in said selected optical states are substantially imperceptible to a person's unaided eye.

41. The article according to claim 21, wherein said security feature is provided on an area of said surface separate from said visual feature.

42. The article according to claim 21, wherein said security feature comprises a printed feature comprising pigment, magnetic, electrical or chemical particles, or fibers, distributed via a random application with said random application providing said security code, said security code being a random security code.

43. An article, comprising:
a surface;
a visual feature included on said surface; and,
a plurality of elements defining information with at least a portion of elements of said plurality of elements being of selected optical states according to a predetermined code, each element of said portion of elements, in one optical state of said selected optical states, playing back light at a different wavelength from a wavelength of light thereon.

44. The article according to claim 43, wherein said elements comprise alpha-numeric characters.

45. An article, comprising:
a surface;
a visual feature included on said surface; and,
a bar-code including a plurality of parallel bars with at least some parallel bars of said plurality of parallel bars being shifted from their nominal positions according to a predetermined code.

46. An article, comprising:
a surface;
a visual feature included on said surface; and,
a bar-code including a plurality of parallel bars with at least some parallel bars of said plurality of parallel bars being modified from their nominal lengths or widths according to a predetermined code.

47. An apparatus for applying a visual feature to a surface of an article, comprising:
means for applying to a surface of an article a plurality of elements forming a visual feature, at least a portion of elements of said plurality of elements being of selected optical states according to a predetermined code so that said visual feature is encoded with information; and,
means for encoding a random security code from a security feature contained with said article, said random security code including a corresponding code included within said visual feature encoded with said information.
